(19) United States
(12) Patent Application Publication
(10) Pub. No.: US 2007/0180031 A1
(43) Pub. Date: Aug. 2, 2007

(54) Email Opt-out Enforcement

(75) Inventors: Pablo M. Stern, San Francisco, CA (US); Eliot C. Gillum, Los Gatos, CA (US); Jason D. Walter, Redmond, WA (US); John E. Tafoya, Granite Bay, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,824

(22) Filed: Jan. 30, 2006

(51) Int. Cl. G06F 15/16

(52) U.S. Cl. 709/206

(57) ABSTRACT

Email opt-out enforcement is described. Received email messages are processed based on trust levels associated with senders of the email messages, such that email from more trusted senders is not scrutinized as much as email from less trusted senders. When a user requests to opt-out or unsubscribe from a sender's mailings, a record of the user's opt-out request is maintained. If the sender continues to send email to the user subsequent to the opt-out request, the trust level associated with the sender is adjusted to reflect a lesser degree of trust in the sender.

### BACKGROUND

Many current email users distrust opt-out links in email messages. Many fear that by opting out, they will confirm their email address to the sender and receive more unwanted email. So, rather than opting out, users are more apt to mark unwanted email messages as spam or Junk mail. This leads to over-reported spam. For example, an electronic newsletter sent to a user may be an acceptable email message from a valid sender. Although the newsletter may be unwanted by the user, it is not content that is typically considered spam or junk mail. If the user marks the message as junk mail instead of selecting an available opt-out link, then the message is erroneously reported as spam.

Some spam filters are based on sender reputation, which may be based, at least in part, on a number or percentage of messages from the sender that are reported by users as spam. When users over-report spam, rather that selecting opt-out links, a sender's reputation may be inappropriately adversely affected.

### SUMMARY

This Summary is provided to introduce a selection of concepts in a simplified form that are further described below in the Detailed Description. This Summary is not intended to identify key features or essential features of the claimed subject matter, not is it intended to be used as an aid in determining the scope of the claimed subject matter.

Email opt-out enforcement is described. Received email messages are processed according to trust levels associated with email senders. For example, email from senders with high trust levels may be delivered without being subjected to one or more spam filters, while email from senders with lower trust levels may be delivered only after passing one or more spam filters. When a user selects an opt-out link or otherwise unsubscribes from an email sender's mailing list, a record of the opt-out request is maintained and delivered to the sender. If the email sender continues to send email to the user after the user has submitted the opt-out request, then a trust level associated with the email sender is adjusted to indicate less trust in the sender.

### BRIEF DESCRIPTION OF THE DRAWINGS

FIG. 1 is a block diagram that illustrates an exemplary network environment in which email opt-out enforcement may be implemented.

FIG. 2 is a block diagram that illustrates select component of an exemplary unwanted email enforcement module.

FIG. 3 is a flow diagram that illustrates an exemplary method for implementing email opt-out enforcement.

### DETAILED DESCRIPTION

Email opt-out enforcement as described below provides a mechanism by which a sender's reputation is negatively affected if the sender does not respond appropriately to a user's opt-out request. When a user submits an opt-out (or unsubscribe) request associated with an email, a record of the opt-out request is generated and maintained by an unwanted email enforcement module. If the user later submits another opt-out request associated with the same email sender or if the user later reports email from the same sender as spam, then the sender's reputation is negatively affected, indicating a diminished trust in the sender. In an alternate implementation, a list of senders from which the user has opted-out may be maintained, and if email addressed to the user is received from one of the senders on the list, then the sender's reputation may be automatically adjusted. In an exemplary implementation, email messages received from senders with significantly high trust levels may be delivered to users after being subjected to a minimum number of spam filters, while email messages received from senders with lower trust levels must pass additional spam filters before being approved for delivery to a user's inbox.

The following discussion is directed to email opt-out enforcement. While features of email opt-out enforcement can be implemented in any number of different computing environments, they are described in the context of the following exemplary implementations.

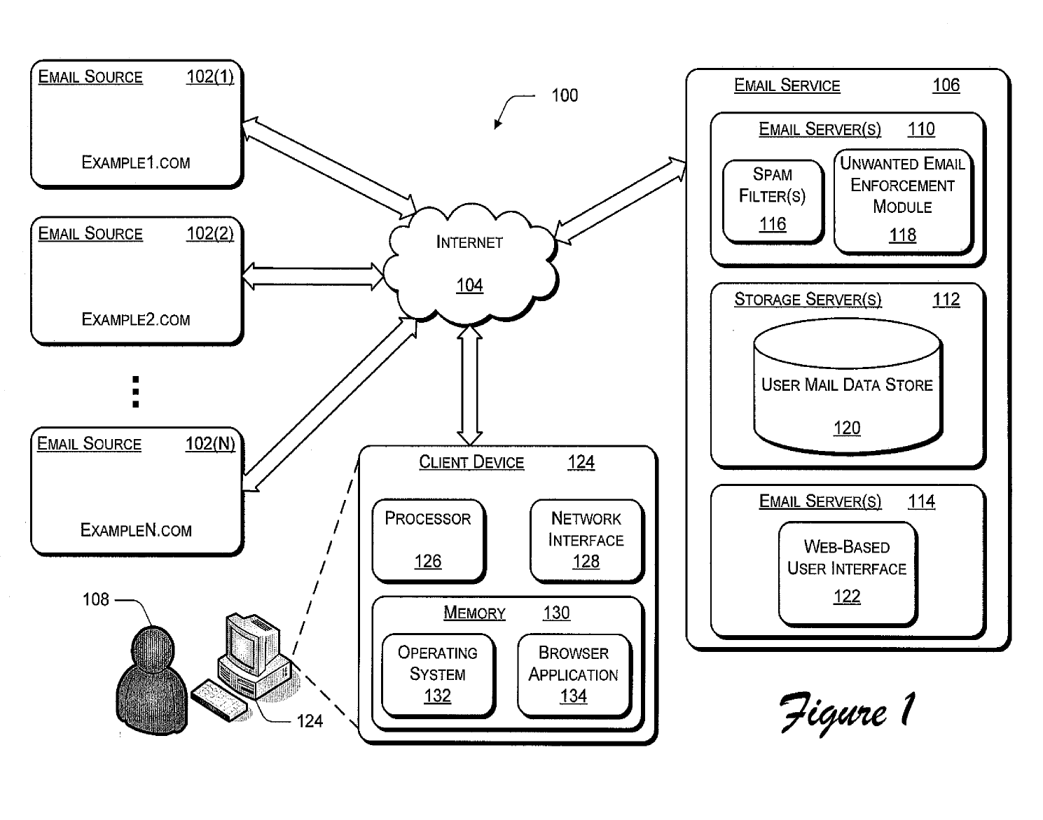

FIG. 1 illustrates an exemplary network environment 100 in which email opt-out enforcement may be implemented. Email senders 102(1), 102(2), . . . , 102(N) represent entities that may send email messages via the Internet 104. An email sender's identity may be determined in any number of ways, such as, but not limited to, an address the email was sent from, a domain the email was sent from, a portion of the domain the email was sent from, or an IP address the email was sent from. Email service 106 enables a user 108 to send and receive email messages. In an exemplary implementation, email service 106 is implemented across multiple servers, such as email server(s) 110, storage server(s) 112, and web server(s) 114.

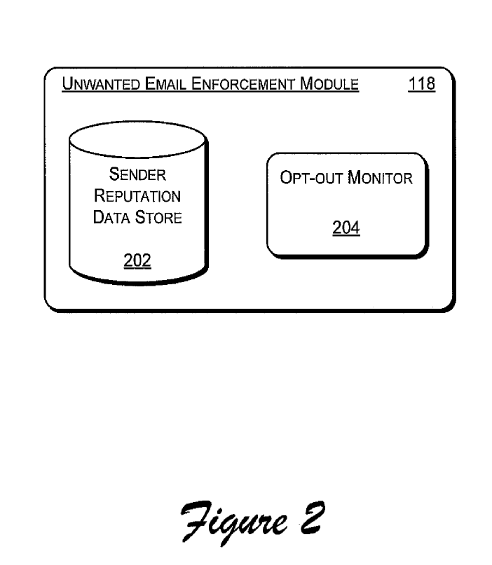

Exemplary email server(s) 110 include one or more spam filters 116 and unwanted email enforcement module 118. Spam filters 116 are selectively applied to received messages before the received messages are delivered to a user's email account. Unwanted email enforcement module 118 determines trust levels associated with one or more email senders 102, based, at least in part, on each sender's propensity to respond appropriately to a user's request to opt-out or unsubscribe from a sender's mailings. An exemplary unwanted email enforcement module 118 is described in further detail below with reference to FIG. 2.

Storage server(s) 112 include user mail data store 120, which maintains data associated with user email accounts. Data maintained by user mail data store 120 may include, for example, received messages, sent messages, draft messages, contact information, and so on, grouped by user email account. Web server(s) 114 include web-based user interface 122, which provides a website via which a user can manage one or more email accounts provided through email service 106.

Client device 124 represents an Internet-enabled computing device via which user 110 can access email service 106. Example implementations of client device 124 may include, but are not limited to, a personal computer, a portable computer, a pocket PC, an Internet-enabled personal data assistant (PDA), an Internet-enabled cell phone, and so on. Client device 124 includes processor 126, network interface 128, and memory 130. Network interface 128 enables client device 124 to send and receive data via the Internet 104. An operating system 132 and a browser application 134 are stored in memory 130 and executed on processor 126. Browser application 134 provides a user interface that enables user 108 to interact with email service 106 via the Internet 104.

FIG. 2 illustrates select components of an exemplary unwanted email enforcement module 118. Unwanted email enforcement module 124 includes sender reputation data store 202 and opt-out monitor 204. Sender reputation data store 202 maintains data associated with one or more email senders 102. Data maintained by sender reputation data store 202 may include, for example, for each sender, a sender trust level, a number of messages received from the sender, a number of reported spam messages received from the sender, user-submitted opt-out requests associated with the sender, and messages received from senders from whom users have opted-out. Any type of data that may be used to determine sender trust levels may also be maintained in sender reputation data store 202. The determination of the sender's identity in the data store can be achieved using various mechanisms. As an example, some email services 106 provide spam reporting mechanisms which allow senders to opt-in to receive user complaints for their mailings. In these systems the sender provides information detailing their identity. This information can then be stored in data store 202 as the identity for which a reputation is derived. In certain instances, one sending entity may opt to split their identity into multiple senders, this may be the case, for example, if company A sends on behalf of multiple companies (e.g., company B, company C, . . . ), each deserving of their own identity. These companies could be identified by the unique IP(s) they send from or potentially by an email header that company A adds to distinguish each company. In an alternative implementation, the sender's source IP or domain may be used to derive and identity. Where domain is used to derive identity, industry standards, such as, Sender ID and DKIM can be used to determine the true domain identity and weed out spoofs.

Opt-out monitor 204 identifies opt-out requests submitted by users, and records the opt-out requests in sender reputation data store 202. In an exemplary implementation, opt-out monitor 204 may also be configured to deliver the opt-out request to the sender on behalf of the user. When an opt-out request is identified, opt-out monitor 204 examines data stored in sender reputation data store 202 to determine whether or not a similar opt-out request has been previously initiated by the same user for the same sender. Based on this data examination, opt-out monitor 204 may negatively adjust a sender's trust level as maintained by sender reputation data store 202 if the sender appears to be responding inappropriately to user-submitted opt-out requests (e.g., the sender continues to send email to a user after receiving an opt-out request from the user). Over time, a sender's trust level may be positively adjusted if it is apparent that the sender is respecting users' opt-out requests. In an exemplary implementation, opt-out monitor 204 may also monitor user-submitted spam reports. By monitoring such spam reports, opt-out monitor 204 can identify situations where a user first submits an opt-out request, and later, upon receiving another unwanted message from the same sender, marks the later message as spam. In this case, opt-out monitor 204 may adjust the sender's trust level to indicate less trust in the sender. Eventually, if it is determined that a sender is defying opt-out requests, the sender may be assigned a very low trust level, and opt-out requests may no longer be sent to the sender.

Methods for implementing email opt-out enforcement may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

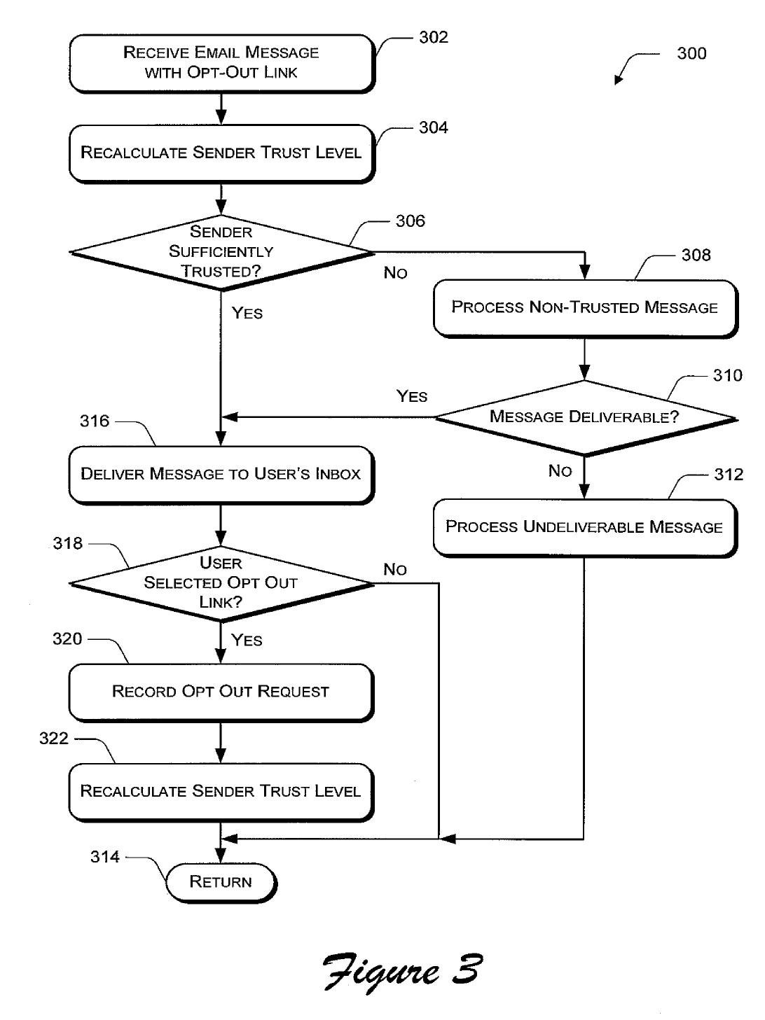

FIG. 3 illustrates an exemplary method 300 for implementing email opt-out enforcement. FIG. 3 is a specific example of email opt-out enforcement, and is not to be construed as a limitation. The order in which the method is described is not intended to be construed as a limitation, and any number of the described method blocks can be combined in any order to implement the method. Furthermore, the method can be implemented in any suitable hardware, software, firmware, or combination thereof.

At block 302, an email message is received that includes an opt-out link. For example, email service 106 receives an email message from an email sender 102.

At block 304, a trust level associated with the sender is recalculated. For example, opt-out monitor 204 may query sender reputation data store 202 to determine whether or not the user to whom the received message is addressed has previously submitted an opt-out request to the sender If so, opt-out monitor 204 may recalculate a lower trust level to be associated with the sender. In an exemplary implementation, a date/time stamp may be stored in association with submitted opt-out requests, and if a sufficient amount of time has not passed since the most recently submitted opt-out request to the sender, then the sender's reputation may not be adjusted. This type of an implementation provides a grace period during which it is expected that the sender's system will be updated to reflect the submitted opt-out request.

At block 306, it is determined whether or not the sender of the received email message is sufficiently trusted. For example, email service 106 queries sender reputation data store 202 to determine a trust level associated with the sender of the received email message. If the sender's trust level is above a pre-specified threshold, then the sender is considered to be sufficiently trusted.

If it is determined that the received message is not from a sufficiently trusted sender (the “No” branch from block 306), ten at block 308, the received email message is processed as a non-trusted message. For example, email service 106 may apply one or more spam filters 116 to the message. In an exemplary implementation, varying degrees of processing may be performed depending on the trust level associated with the sender such that, for example, email received from a less trusted sender is filtered more strictly than email received from a more trusted sender.

At block 310, it is determined whether or not the non-trusted message is deliverable. For example, if the message passes spam filters 116, it may be determined to be deliverable. If the message is deliverable (the “Yes” branch from block 310), then processing continues as described below with reference to block 316. If the message is not determined to be deliverable (the “No” branch from block 310), then at block 312, the undeliverable message is processed. For example, the message may be deleted (i.e., not delivered at all), or it may be delivered to the user's junk mail box. Processing of the message is then complete, as indicated by block 314.

If the message is determined to be from a sufficiently trusted sender (the “Yes” branch from block 306), or an initially untrusted message that is determined to be deliverable (the “Yes” branch from block 310), then at block 316, the received message is delivered to the inbox to which the message is addressed. For example, email service 106 adds the received message to user mail data store 120.

At block 318 it is determined whether or not a user has selected an opt-out link associated with the email message. For example, opt-out monitor 204 is notified if a user selects an opt-out link associated with the received email message.

If no user-selected opt-out is detected (the “No” branch from block 318), then processing of the email message is complete, as indicated by block 314.

On the other hand, if a user-selected opt-out is detected (the “Yes” branch from block 318), then at block 320, the opt-out request is recorded and sent to the sender of the email message. For example, if opt-out monitor 204 detects an opt-out request associated with the received email message, then a record of the opt-out request is added to sender reputation data store 202.

At block 322, a trust level associated with the sender of the email message is recalculated. For example, opt-out monitor 204 may recalculate a lower trust level if the detected opt-out request is not the first opt-out request received from the user in association with a message from the same sender, or if a large percentage of users have submitted opt-out requests for the same sender.

Although embodiments of email opt-out enforcement have been described in language specific to structural features and/or methods, it is to be understood that the subject of the appended claims is not necessarily limited to the specific features or methods described. Rather, the specific features and methods are disclosed as exemplary implementations of email opt-out enforcement.

1. A computer-implemented method comprising:
receiving a first email message from a sender, the first email message being addressed to a user;
receiving an indication of a user-submitted opt-out request associated with the first email message; and
maintaining a record of the opt-out request, such that a response by the sender to the opt-out request can be monitored.

2. The method as recited in claim 1, further comprising:
determining a trust level associated with the sender; and
in an event that the trust level is above a threshold value, delivering the first email message as a trusted email message.

3. The method as recited in claim 1, further comprising:
determining a trust level associated with the sender;
in an event that the trust level is below a threshold value, applying a spam filter to the first email message; and
in an event that the first email message passes the spam filter, delivering the first email message to the user's inbox.

4. The method as recited in claim 1, further comprising:
determining a trust level associated with the sender;
in an event that the trust level is below a threshold value, processing the first email message as an untrusted email message.

5. The method as recited in claim 4, wherein processing the first email message as an untrusted email message comprises refusing to deliver the first email message.

6. The method as recited in claim 4, wherein processing the first email message as an untrusted email message comprises:
applying a spam filter to the first email message; and
in an event that the first email message fails to pass the spam filter, delivering the first email message to the user's junk mailbox.

7. The method as recited in claim 1, further comprising:
receiving a second email message from the sender, the second email message being addressed to the user; and
determining that the second email message defies the opt-out request; and
reducing a trust level associated with the sender to reflect that the sender is less trusted.

8. The method as recited in claim 7, wherein the determining comprises:
delivering the second email message to the user; and
receiving an indication of a user-submitted opt-out request associated with the second email message.

9. The method as recited in claim 7, wherein the determining comprises:
delivering the second email message to the user; and
receiving an indication of a user-submitted spam report associated with the second email message.

10. An email service comprising:
a user mail data store configured to maintain data associated with a user email account;
an unwanted email enforcement module configured to monitor an email sender's response to a user-submitted opt-out request.

11. The email service as recited in claim 10, wherein the unwanted email enforcement module comprises:
a sender reputation data store configured to maintain a trust level associated with the email sender; and
an opt-out monitor configured to record user-submitted opt-out requests.

12. The email service as recited in claim 11, wherein the opt-out monitor is further configured to adjust the trust level associated with the email sender to indicate less trust in the sender in an event that the sender continues to send email that defies a user-submitted opt-out request.

13. The email service as recited in claim 11, wherein the opt-out monitor is further configured to adjust the trust level associated with the email sender to indicate more trust in the sender in an event that the sender does not send email that defies a user-submitted opt-out request for a particular period of time.

14. One or more computer-readable media comprising computer-readable instructions which, when executed, cause a computer system to:
receive an indication of a first unwanted email notification submitted by a user, the first unwanted email notification associated with a first email message having an associated sender;
maintain an indication of the unwanted email notification to facilitate enforcement of the unwanted email notification.

15. The one or more computer-readable media as recited in claim 14, wherein the unwanted email notification comprises at least one of a spam report or an opt-out request.

16. The one or more computer-readable media as recited in claim 14, further comprising computer-readable instructions which, when executed, cause the computer system to:
receive a second email message addressed to the user from the sender;
determine a trust level associated with the sender; and
in an event that the trust level is above a threshold value, deliver the second email message to the user without further processing.

17. The one or more computer-readable media as recited in claim 14, further comprising computer-readable instructions which, when executed, cause the computer system to:
receive a second email message addressed to the user from the sender;
determine a trust level associated with the sender; and
in an event that the trust level is below a threshold value, process the second email message as an untrusted email message.

18. The one or more computer-readable media as recited in claim 17, farther comprising computer-readable instructions which, when executed, cause the computer system to process the second email message as an untrusted email message by:
applying a spam filter to the second email message; and
in an event that the second email message passes the spam filter, delivering the second email message to the user.

19. The one or more computer-readable media as recited in claim 17, further comprising computer-readable instructions which, when executed, cause the computer system to process the second email message as an untrusted email message by preventing the second email message from being delivered.

20. The one or more computer-readable media as recited in claim 14, further comprising computer-readable instructions which, when executed, cause the computer system to:
receive an indication of a second unwanted email notification submitted by the user, the second unwanted email notification associated with a second email message having the associated sender; and
reducing a trust level associated with the sender to indicate the sender's failure to respect the first unwanted email notification.
